(19) United States
(12) Patent Application Publication
(10) Pub. No.: US 2007/0056336 A1
(43) Pub. Date: Mar. 15, 2007

(54) Contoured composite structure locking system

(76) Inventor: Lee Lynch, Santa Barbara, CA (US)

Correspondence Address: FELIX L. FISCHER, ATTORNEY AT LAW, 1607 MISSION DRIVE, SUITE 204, SOLVANG, CA, 93463, US

(21) Appl. No.: 11/219,086

(22) Filed: Sep. 1, 2005

(51) Int. Cl. E05B 73/00

(52) U.S. Cl. 70/58

(57) ABSTRACT

A contoured composite locking system incorporates an installation cup mountable within a foam core structure of a foam composite surface and having means for engaging the foam core. A plug is installed within the receiver cup, the plug incorporating an eyelet for the shank of a restraint and a contoured cap to preclude interference with or injury to a user.

### BACKGROUND OF THE INVENTION

1. Field of the Invention

This invention relates generally to the field of portable object locking systems and, more particularly, to an insertable contoured locking system for surfboard and other watercraft or devices employing foam composite construction.

2. Description of the Related Art

Surfboards and windsurfing boards have become increasingly popular for recreational use. While graceful and easily manipulated in the water and while light weight based on foam composite construction techniques, the size and bulky form of these articles on the beach often makes it desirable to store or leave them unattended while pursuing other activities. Similar difficulties arise with other recreational water craft such as kayaks, boogie boards, knee boards or devices made from foam composite construction.

To prevent theft of these articles, various locking systems have been devised such as those disclosed in U.S. Pat. No. 4,712,394 to Bull issued Dec. 15, 1987 entitled Surf Lock; U.S. Pat. No. 4,680,949 to Stewart issued Jul. 21, 1987 entitled Locking Device for Articles Such As Sailboards; U.S. Pat. No. 5,119,649 to Spence issued Jun. 9, 1992 entitled Locking Device for Recreational Articles; U.S. Pat. No. 6,688,145 to Tan issued Feb. 10, 2004 entitled Sports Board Locking Apparatus and Method; and U.S. Pat. No. 6,691,537 to Tan issued Feb. 17, 2004 entitled Sports Board Locking Apparatus. However, these systems employ attachments that typically cannot be in place while the article is in use or can be lost misplaced when not attached to the article. Additionally, these devices tend to have complex mechanical arrangements that are expensive to produce.

It is therefore desirable to have a locking system for surf boards and similar articles that can remain in place during use of the board without interfering with the user or causing potential injury. Additionally, it is desirable to have a locking system that does not require additional complex devices for use.

### SUMMARY OF THE INVENTION

A contoured composite locking system according to the present invention incorporates an installation cup mountable within a core structure of a composite surface and having means for engaging the core. A plug is installed within the receiver cup, the plug incorporating an eyelet for the shank of a restraint and a contoured cap to preclude interference with or injury to a user.

### BRIEF DESCRIPTION OF THE DRAWINGS

These and other features and advantages of the present invention will be better understood by reference to the following detailed description when considered in connection with the accompanying drawings wherein:

FIG. 1 is an isometric section view of an embodiment of the present invention;

FIG. 2a is an isometric view of the cup element of the embodiment of FIG. 1;

FIG. 2b is a top view of the cup element;

FIG. 2c is a side section view of the cup element along section line 2c-2c in FIG. 2b;

FIG. 2d is a side section view of the cup element along section line 2d-2d in FIG. 2b;

FIG. 3a is an isometric view of the plug element of the embodiment of FIG. 1;

FIG. 3b is a top view of the plug element;

FIG. 3c is a side section view of the plug element along section line 3c-3c in FIG. 3b;

FIG. 3d is a side section view of the plug element along section line 3d-3d in FIG. 3b;

FIG. 3e is a side view of the plug;

FIG. 3f is a section view of the plug along section line 3f-3f in FIG. 3d;

FIG. 4a is a side view of the security ring;

FIG. 4b is an isometric view of the ring;

FIG. 4c is a section view of the ring; and,

FIG. 5 is an exploded isometric view of the embodiment of FIG. 1 showing the plug prior to insertion into the cup as installed in a foam composite surface and the ring prior to molding into the plug.

### DETAILED DESCRIPTION OF THE INVENTION

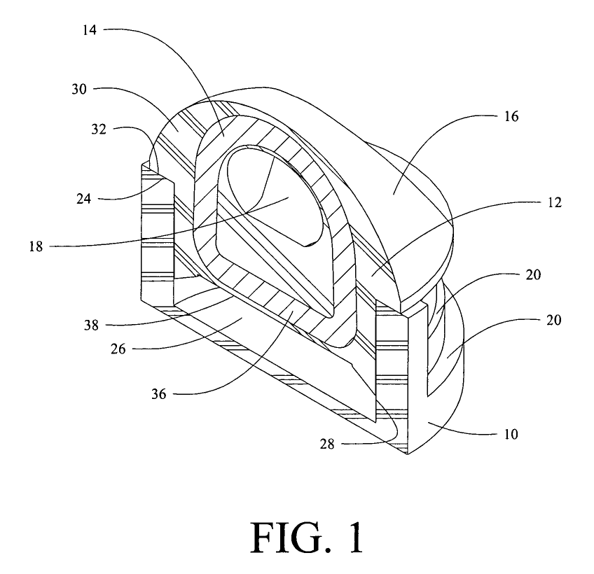

Referring to the drawings, the present invention is incorporated in a current embodiment shown in FIG. 1. A cup 10 is employed for mounting within the foam composite of a surfboard, as an exemplary use, during fabrication of the board. Composite structures having a core with comparable properties to foam such as balsa or structural matrix elements are employed in alternative embodiments. A plug 12 is received in the cup after fabrication of the board is complete, as will be described in greater detail subsequently. Molded into the plug is a security ring 14 for structural strength in the locking element. The plug has a contoured outer surface 16 which includes an eyelet 18 extending through the ring.

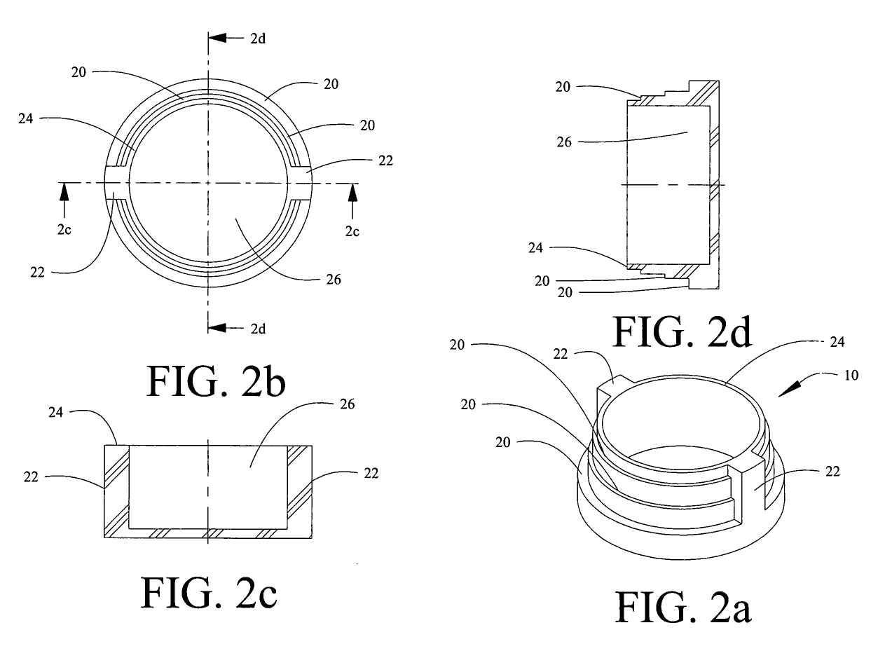

Turning to FIGS. 2a-2d, for the embodiment shown, the cup employs multiple engaging steps 20 formed by spaced reductions in the cylindrical diameter of the cup to allow the cup to be firmly secured within the foam composite structure by increasing the “pull out” area at the base of the cup with foam or resin fill overlying the steps depending on the fabrication technique used for the board. In alternative embodiments, ribs or flanges extending from the substantially cylindrical body of the cup perform the structural function of the steps. Vertical risers 22 are incorporated in the cup to provide lateral surface area to resist rotational movement of the cup within the foam composite. Two diametrically opposed risers are shown in the exemplary embodiment in the drawings, however a single riser or other combinations of multiple risers are employed in alternative embodiments. The cup employs a flat rim 24 which can be sanded flush with the board surface during finishing without impacting the normal sanding or profiling operations for the board. The central cavity 26 in the cup receives the plug.

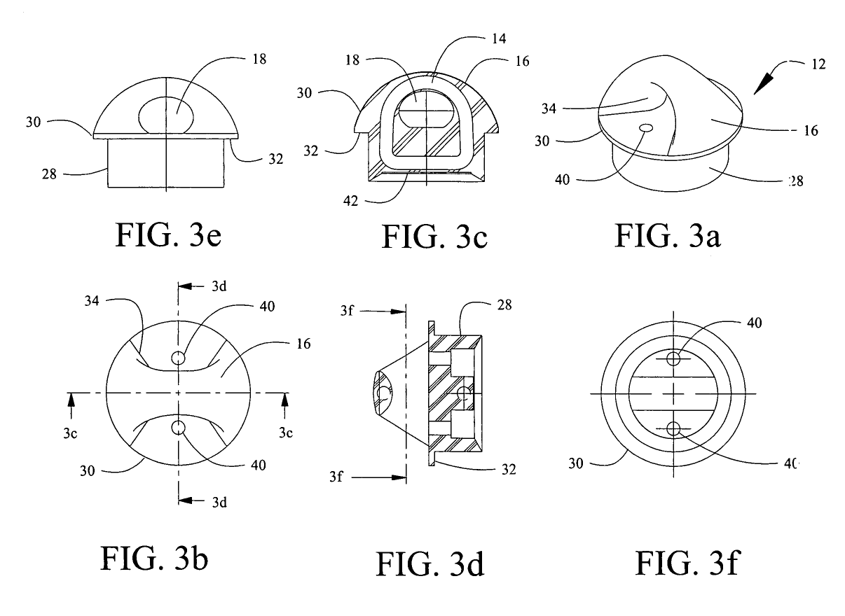

Details of the plug are shown in FIGS. 3a-3d. A cylindrical body 28 is provided to be received in the central cavity of the cup. For the embodiment shown, the cylindrical body is recessed diametrically inward from the circumference of a cap 30 which incorporates the contoured upper surface of the plug. The land 32 projecting from the body engages the flat rim of the cup. In alternative embodiments, the land extends beyond the diameter of the cup rim to engage not only the cup but a portion of the upper surface of the board. The security ring is molded into the body and cap of the plug to provide the maximum structural integrity for receiving the hasp of a standard padlock or locking cable to secure the board. The eyelet is molded into the plug to substantially cover the ring while providing the necessary opening for the lock or cable. The contoured surface of the plug is smoothly arcuate to avoid snagging on the users clothing or causing injury to skin or feet during use of the board. The eyelet additionally is employable as an attachment for a leash commonly used on surf boards thereby avoiding or replacing the requirement for a separate leash attachment point on the board. Additionally, the surfaces of the cap surrounding the eyelet, nominally designated 34 are curvilinearly contoured to prevent leveraging points or surfaces where the locking hasp or cable could be used as a lever to pry the plug and cup from the surface of the board.

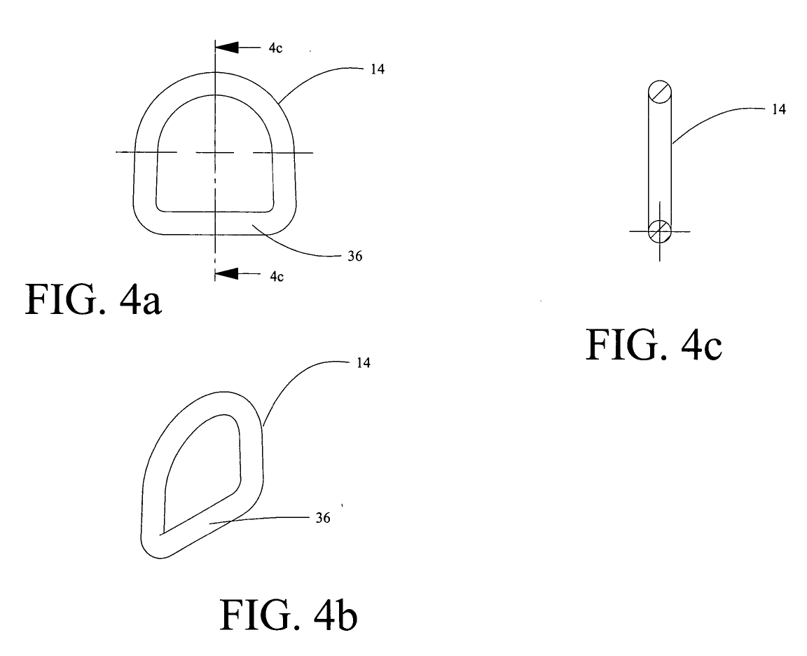

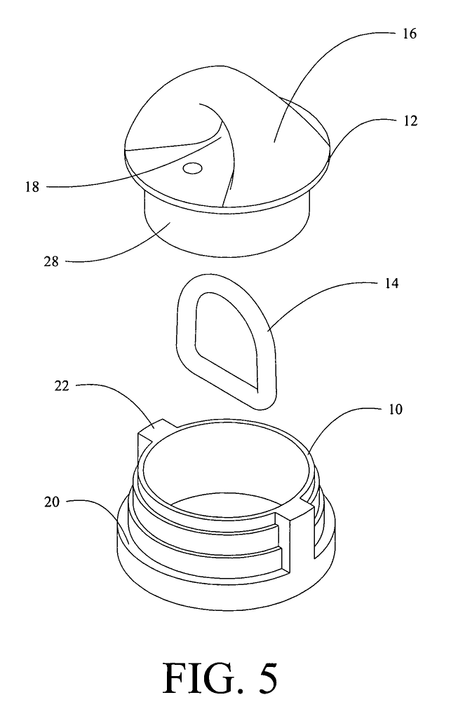

The security ring for the embodiment disclosed herein is shown in detail in FIGS. 4a-4c. A D-shaped ring fabricated from stainless steel is employed having a flat bottom 36 to reduce the required axial dimension of the plug and cap, however, in alternative embodiments, a circular ring or quadrilateral member are employed for the increased structural support necessary while relaxing or increasing the axial dimensional requirements respectively. Similarly, for the current embodiment, the ring is substantially circular in cross section. Alternative cross sections such as rectangular or star shaped for additional mold material engagement within the plug are employed if dictated by molding material selection.

The form and function of the elements of the present embodiment of the invention contribute to ease of integration into existing fabrication processes for the surf boards or other articles into which the locking system is incorporated. The cup and plug are molded in Polyvinyl Chloride (PVC) for the current embodiment using molding techniques with the security ring molded into the plug as known in the art. Alternative plastics such as Acrylonitrile-butadiene styrene (ABS) may be employed in alternative embodiments.

As an exemplary installation method, the normal foam core shaping of the surfboard and laminating with fiberglass or alternative covering is accomplished followed by or including drilling of a bore in the tail portion of the board having a diameter substantially equal to the base of the cup and a depth sufficient to position the flat rim at the composite surface upon surface finishing. For the drawing, the bore is shown in the foam core, however, in alternative embodiments placement of the bore in a structural member is employed. The cup is inserted into the bore with a mild interference fit or an interim adhesive bond. With a temporary plug or tape covering on the cup to avoid undesired ingress of resin into the cup, resin coating and final glassing or other structural composite skinning of the foam core is accomplished with resin matrix including the cylindrical contour of the bore filling over the steps of the cup and laterally surrounding the risers in the cup. The flat surface of the rim of the cup with no protuberances allows normal sanding or other surface finishing operations to be conducted on the board without interference. Completion of the surface finishing provides the flat rim of the cup flush with the surface of the board.

The plug is then inserted into the cup using a structural adhesive to secure the plug to the cup. As shown in the drawings, the plug incorporates relief ports 40 extending through the material of the plug for pressure relief during insertion of the plug into the cup to allow tight tolerances to be maintained between the cavity of the cup and the plug body to enhance structural integrity of the adhesive bond. Additionally, a relief 38, as shown in FIG. 1, in the base of the plug body allows a volume for accumulation of excess adhesive to assure flush engagement of the land on the plug cap with the flat rim on the cup. For the embodiment shown, the length of the body of below the land on the cap of the plug is less than the vertical dimension of the cavity in the cup to provide further volumetric relief. Side bores into the foam surrounding the bore are provided in alternative method embodiments (such as that described subsequently) for adding resin spokes into the foam to enhance rotational resistance in the completed installation.

As an aftermarket installation, the current invention can be installed in a surf board or other article using comparable method steps. A bore is drilled into the surf board centered on the middle stringer having a depth substantially equal to or slightly less than the height of the cup. Foam is removed from the bore and the cup fit into the bore to confirm the dimensions. The cup is removed. Lateral bores extending from the drilled bore are made into the foam using a piercing tool.

Surface preparation of the cup is accomplished and the cavity of the cup is temporarily sealed using a foam piece or tape. The bore is filled approximately half full of resin and the cup is inserted into the bore, displacing the resin into the side bores and to the lip or the bore or overflowing onto the surface of the board. Excess resin is removed and the temporary plug removed from the cup.

The resin is allowed to set completely and surface finishing around the bore and cup rim is accomplished including sanding of the flat rim substantially flush with the board surface. The surface of the body of the plug and land are prepared and adhesive applied to the cup cavity and plug body. The plug is inserted into the cup with desired alignment of the eyelet and flush engagement of the land and rim.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A contoured composite locking system comprising:
an installation cup mountable within a core of a composite structure and having means for engaging the core;
and a contoured plug installed within a cavity in the receiver cup, the plug incorporating an eyelet for a shank of a restraint.

2. A contoured composite locking system as defined in claim 1 wherein the means for engaging the core comprises a plurality of engaging steps formed by spaced reductions in a cylindrical external diameter of the cup.

3. A contoured composite locking system as defined in claim 2 wherein the means for engaging the core further comprises vertical risers incorporated in the cylindrical external diameter of the cup to provide lateral surface area to resist rotational movement of the cup within the composite.

4. A contoured composite locking system as defined in claim 1 wherein the plug incorporates an integral structural ring surrounding the eyelet.

5. A contoured composite locking system as defined in claim 1 wherein the eyelet of the plug is curvilinearly contoured to prevent leveraging surfaces for the restraint.

6. A contoured composite locking system as defined in claim 1 wherein the cup incorporates a flat rim to be sanded flush with an external surface of the composite.

7. A contoured composite locking system as defined in claim 1 wherein the plug incorporates a cylindrical body recessed diametrically inward from a circumference of a cap which incorporates a contoured upper surface for the plug.

8. A contoured composite locking system as defined in claim 7 wherein the contoured upper surface is smoothly arcuate to avoid snagging on a users clothing or causing injury to skin or feet during use.

9. A contoured composite locking system as defined in claim 7 wherein the cap includes a land projecting from the body to engage a flat rim of the cup.

10. A contoured composite locking system as defined in claim 7 wherein the body further incorporates a relief on a bottom surface to accommodate volumetric displacement of adhesive bonding the plug to the cup.

11. A contoured composite locking system as defined in claim 7 wherein the plug incorporates relief ports.

12. A contoured composite locking system as defined in claim 7 wherein the cylindrical body of the plug has a length less than a vertical dimension of the cavity in the cup.

13. A method for installation of a contoured composite locking system in a composite surface with a core comprising the steps of:
molding an installation cup with a central cavity and external engaging means;
molding a plug with a contoured cap having an eyelet;
shaping the core;
drilling a bore in a selected portion of the core having a substantially cylindrical contour and diameter substantially equal to a base of the cup and a depth sufficient to position a flat rim of the cup at the composite surface upon surface finishing;
inserting the cup into the bore;
installing a temporary covering on the cup to avoid undesired ingress of resin into the cup;
resin coating or other structural composite skinning of the core with resin matrix including the cylindrical contour of the bore and the engaging means;
conducting surface finishing operations with a flat rim of the cup flush with the surface;
inserting the plug into the cup using a structural adhesive to secure the plug to the cup;

14. A method as defined in claim 13 wherein the step of inserting the cup includes applying an interim adhesive bond.

15. A method as defined in claim 13 wherein the engaging means for the cup comprises steps in a cylindrical external diameter of the cup and vertical risers in the external diameter, and the step of resin coating includes filling over the steps of the cup and laterally surrounding the risers in the cup.

16. A method as defined in claim 13 wherein molding the plug includes providing relief ports extending through the material of the plug for pressure relief during insertion of the plug into the cup

17. A method as defined in claim 13 wherein molding the plug includes providing a relief in the base of the plug body to allow a volume for accumulation of excess adhesive to assure flush engagement of a land on the plug cap with a flat rim on the cup.

18. A method as defined in claim 13 prior to the step of inserting the cup further comprising the step of creating side bores into the core surrounding the bore for adding resin spokes into the core to enhance rotational resistance in the completed installation.
